(19) United States
(12) Patent Application Publication
(10) Pub. No.: US 2006/0197899 A1
(43) Pub. Date: Sep. 7, 2006

(54) Method of fabricating alignment film of liquid crystal display and etching apparatus used therein

(76) Inventors: Hiroyuki Kamiya, Seongnam-si (KR); Soon Joon Rho, Suwon-si (KR); Baek-Kyun Jeon, Yongin-si (KR)

Correspondence Address: CANTOR COLBURN, LLP, 55 GRIFFIN ROAD SOUTH, BLOOMFIELD, CT, 06002, US

(21) Appl. No.: 11/319,088

(22) Filed: Dec. 27, 2005

(30) Foreign Application Priority Data
Mar. 4, 2005 (KR) 10-2005-0018257

(51) Int. Cl. G02F 1/1337

(52) U.S. Cl. 349/124

(57) ABSTRACT

Provided are a method of fabricating an alignment film of a liquid crystal display device, which is capable of simply patterning the alignment film at an accurate location and an etching apparatus used therein. The method includes forming an alignment film on a substrate having an electrode pad at a position corresponding to a transfer electrode for applying a voltage to a common electrode, and locally etching the alignment film to expose the electrode pad without using a mask pattern.

This application claims priority to Korean Patent Application No. 10-2005-0018257 filed on Mar. 4, 2005, and all the benefits accruing therefrom under 35 U.S.C. § 119, the contents of which is incorporated herein by reference in its entirety.

### BACKGROUND OF THE INVENTION

1. Field of the Invention

The present invention relates to a method of fabricating an alignment film of a liquid crystal display device and an etching apparatus used therein, and more particularly, to a method of fabricating an alignment film by locally etching the alignment film without using a mask pattern, and an alignment film etching apparatus thereof.

2. Description of the Related Art

In general, displaying an image using a liquid crystal display (LCD) involves a liquid crystal (LC) alignment technique in which liquid crystal molecules are aligned in a given direction.

Traditionally, LC alignment has been carried out by forming an alignment film by printing an organic thin film made of polyimide or polymer on a substrate and forming align grooves on the alignment film using a roller wound with cloth such as velvet.

In a case of forming an alignment film using an organic thin film, a potential location of the alignment film must be precisely controllable along an active area on a substrate, and a printing technique of forming the alignment film having a uniform thickness is needed. Unfortunately, as a mother glass substrate becomes larger in size, it is quite difficult to meet such requirements. In particular, when an organic alignment film made of polyimide is exposed to intense UV light for a long period of time, the alignment film may be denatured, which may deteriorate the alignment property of the alignment film.

Recently, to overcome such shortcomings, development of new alignment films using inorganic materials have been attempted. One example of newly proposed alignment films is a diamond-like-carbon (DLC) thin film.

In the conventional method of using the DLC thin film, the DLC thin film is formed on a substrate by plasma enhanced CVD (PECVD). A liquid crystal display device includes a color filter substrate and a TFT substrate. A common electrode formed on the entire surface of the color filter substrate is electrically connected with the TFT substrate through a transfer electrode. To electrically connect the TFT substrate with the color filter substrate through the transfer electrode, it is necessary to pattern a DLC thin film disposed on an electrode pad to expose the electrode pad so it can be adhered to the transfer electrode. The DLC thin film is patterned by a photolithography process to expose the electrode pad.

As described above, the conventional method of using the DLC thin film involves a photolithographic process for patterning the DLC thin film, requiring masks, exposure equipment, etching equipment, and so on. That is, a large amount of time and a large number of processing equipment are required for forming an alignment film, resulting in an increase in the fabricating cost.

### BRIEF SUMMARY OF THE INVENTION

The present invention provides a method of fabricating an alignment film of a liquid crystal display device by which the alignment film can be patterned at an accurate position. The present invention also provides an alignment film etching apparatus used in the method of fabricating the alignment film.

The above stated objects as well as other objects, features and advantages, of the present invention will become clear to those skilled in the art upon review of the following description, the attached drawings and appended claims.

According to an aspect of the present invention, there is provided a method of fabricating an alignment film of a liquid crystal display device including forming an alignment film on a substrate that has an electrode pad at a position corresponding to a transfer electrode for applying a voltage to a common electrode, and etching the alignment film to expose the electrode pad without using a mask pattern.

According to another aspect of the present invention, there is provided an alignment film etching apparatus for manufacturing a liquid crystal display device including a high voltage electrode to which a high frequency voltage power is supplied, a ground electrode, and a dielectric nozzle disposed between the high voltage electrode and the ground electrode, the dielectric nozzle generating atmospheric plasma for etching an alignment film to form an electrode pad at a portion corresponding to a transfer electrode for applying a common voltage supplied from a thin film transistor (TFT) substrate to a common electrode formed on a color filter substrate, wherein the alignment film is disposed on at least one of the TFT substrate and the color filter substrate.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of an alignment film etching apparatus of a liquid crystal display device according to an embodiment of the present invention;

FIG. 2A is a graph illustrating an etching speed of a diamond-like-carbon (DLC) alignment film according to processing temperatures of the alignment film etching apparatus shown in FIG. 1;

FIG. 2B illustrates an image of an alignment film locally etched by the alignment film etching apparatus shown in FIG. 1;

FIG. 3 is a flow diagram illustrating a method of fabricating a liquid crystal display device using an alignment film according to an embodiment of the present invention;

FIG. 4 is a plan view of a TFT substrate having the alignment film fabricated by the method according to the embodiment of the present invention shown in FIG. 3; and

FIG. 5 is a cross-sectional view of a liquid crystal display device including the TFT substrate having the alignment film shown in FIG. 3 and a color filter substrate.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

A method of fabricating an alignment film of a liquid crystal display device according to an embodiment of the present invention and an alignment film etching apparatus used therein will now be described in detail.

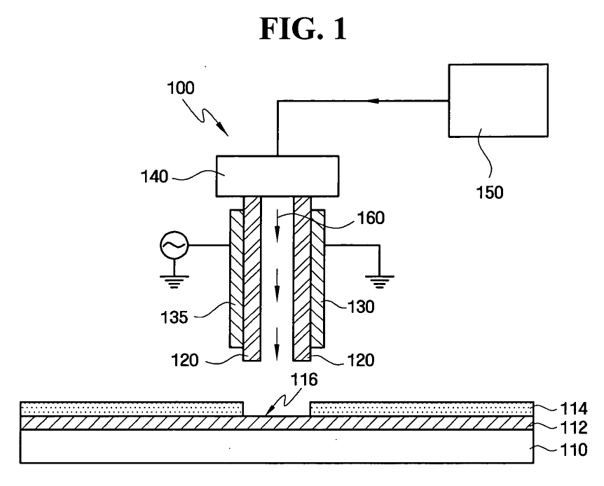

FIG. 1 is a schematic diagram of an alignment film etching apparatus 100 of a liquid crystal display device according to an embodiment of the present invention.

Referring to FIG. 1, the alignment film etching apparatus 100 includes a high voltage electrode 135 to which high frequency voltage power is supplied, a ground electrode 130, and a dielectric nozzle 120 interposed between the high voltage electrode 135 and the ground electrode 130 and having atmospheric plasma for etching an alignment film 114 formed therein. That is, the alignment film etching apparatus 100 according to the present invention locally etches the alignment film 114 using atmospheric plasma without using a mask pattern.

The high voltage electrode 135 and the ground electrode 130 oppose each other and are arranged substantially perpendicular to a substrate 110. The dielectric nozzle 120, which is interposed between the high voltage electrode 135 and the ground electrode 130, insulates the high voltage electrode 135 and the ground electrode 130 from each other and is used as a supply path of reactant gas 160 for forming atmospheric plasma.

A mass flow controller (MFC) 140 for controlling the flow of the reactant gas 160 to the nozzle 120 is installed at an upper portion of the nozzle 120. A reactant gas supply unit 150 for supplying the reactant gas 160 to the nozzle 120 is connected to the MFC 140. In alternative embodiments, however, the reactant gas supply unit may be disposed within the MFC.

When the reactant gas 160 passes the nozzle 120 from the MFC 140, a high frequency voltage is applied between the high voltage electrode 135 and the ground electrode 130, so that glow discharge occurs. As a result, the reactant gas 160 is transformed into plasma.

A “plasma” state refers to an electrically neutral state in which neutral atoms or molecules are energized to be separated into ions and electrons. Plasma is in a high energy state compared to gas, and contains a large amount of highly reactive radicals, so an object to be etched can be etched. As the reactant gas 160 passes through the nozzle 120, a plasma density gradually increases. When the reactant gas 160 is separated from the high voltage electrode 135 and the lower end of the ground electrode 130, the plasma density decreases and an amount of reactive radicals decreases accordingly.

A conductive film 112 and the alignment film 114 sequentially formed on the substrate 110 are disposed under the nozzle 120. In an exemplary embodiment, a TFT substrate or a color filter substrate may be used as the substrate 110 and an inorganic alignment film may be used as the alignment film 114, forming a liquid crystal display device.

The TFT substrate includes a plurality of gate lines, data lines, and pixel electrodes. The gate lines extend in a row direction for transmission of gate signals, and the data lines extend in a column direction for transmission of data signals. The pixel electrodes are connected to the gate lines and the data lines, and include switching elements, and sustain capacitors.

The color filter substrate may be positioned on the TFT substrate and includes red (R), green (G), and blue (B) color filters at regions corresponding to the pixel electrodes to represent colors for the respective pixels. A common electrode made of a transparent conductive material such as ITO (Indium Tin Oxide) or IZO (Indium Zinc Oxide) is formed on the color filters.

A liquid crystal display includes a TFT substrate, a color filter substrate, and a liquid crystal layer having refractive index anisotropy and interposed between the TFT substrate and the color filter substrate. The liquid crystal layer undergoes a change in its orientation by an externally applied voltage to adjust transmittance of light passing through the liquid crystal layer. An alignment film for achieving alignment of the liquid crystal layer is formed on the TFT substrate and the color filter substrate.

Here, a common voltage is applied to the common electrode formed on the color filter substrate through the TFT substrate. To this end, a conductive transfer electrode is formed to connect the common electrode formed on the color filter substrate with the conductive film on the TFT substrate.

Since the alignment film is formed between the conductive film on the TFT substrate and the transfer electrode, it is necessary to expose a predetermined portion of the conductive film, that is an electrode pad on the conductive film, for adhering the transfer electrode to the electrode pad by locally etching the alignment film at the location of the electrode pad. In addition, since the alignment film is formed between the common electrode of the color filter substrate and the transfer electrode, it is also necessary to form a common electrode having a predetermined exposed portion, that is an electrode pad, for adhering the transfer electrode to the electrode pad on the common electrode, by locally etching the alignment film at the location of the electrode pad on the common electrode.

Use of the alignment film etching apparatus 100 according to an embodiment of the present invention allows the conductive film 112 having a predetermined exposed portion, that is, an electrode pad 116, by locally etching a surface of the alignment film 114 disposed under the nozzle 120 having a lower end through which atmospheric plasma generated from the reactant gas 160 is drained out. Here, a transparent conductive film such as ITO (Indium Tin Oxide) or IZO (Indium Zinc Oxide), or a metal wiring can be used as the conductive film 112.

In a case where the substrate 110 shown in FIG. 1 is a color filter substrate, the conductive film 112 may be a common electrode formed on the color filter. In addition, in a case where the substrate 110 is a TFT substrate, the conductive film 112 may be a wiring formed on the TFT substrate in order to apply a common voltage to the common electrode.

For example, an inorganic alignment film may be used as the alignment film 114. Examples of the alignment film 114 include diamond-like-carbon (DLC), hydrogenated amorphous silicon, silicon carbide (SiC), silicon dioxide (SiO₂), glass, silicon nitride (Si₃N₄), alumina (Al₂O₃), cerium IV oxide (CeO₂), tin oxide (SnO₂), zinc titanate (ZnTiO₂), and so on. From the viewpoints of transparency and hardness, a DLC thin film may be employed as the alignment film 114. Since the inorganic alignment film 114 is formed using PECVD, a so-called thin film deposition process, production thereof is advantageous compared to the prior art in which a printing method using a resin plate is employed. The present invention is not limited to the inorganic alignment film and can be applied to an organic alignment film. However, for the sake of convenient explanation, the present invention will be described through an inorganic alignment film by way of example.

In the example, the alignment film 114 is well etched but the conductive film 112 disposed under the alignment film 114 is hardly etched by the atmospheric plasma generated from the reactant gas 160. That is to say, use of the reactant gas 160 having a high etching selectivity with respect to the alignment film 114 protects the conductive film 112 from being damaged while the alignment film 114 is etched.

Useful examples of the reactant gas 160 include air, He, O₂, F₂, or a combination thereof. For example, in order to control a reaction speed, a gas such as He, O₂, F₂ or a combination thereof may be added to the air.

In performing patterning to attain a uniform profile by locally etching the alignment film 114, an etching speed using atmospheric plasma is an important factor. Thus, power and frequency applied to the high voltage electrode 135 arranged around the nozzle 120, a supply amount of the reactant gas 160 induced from the MFC 140, a processing temperature for etching, and a shape of the nozzle 120, are appropriately adjusted, thereby etching the alignment film 114 with an area of less than several millimeters in diameter.

For example, an internal diameter of the nozzle 120 is made smaller than a diameter of the electrode pad 116, thereby controlling an etched area of the alignment film 114.

In addition, the number of the nozzles 120 can be appropriately determined according to the size of a mother glass plate, the number of transfer electrodes, and a tact time required by the processing line.

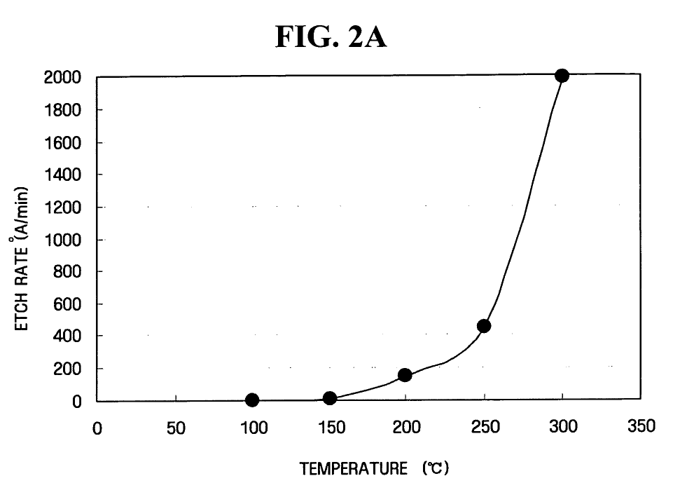

FIG. 2A is a graph illustrating an etching speed of a diamond-like-carbon (DLC) alignment film according to processing temperatures of the alignment film etching apparatus 100 shown in FIG. 1. In this experimental example, the DLC thin film was deposited to a thickness of approximately 150 Å, and then an O₂ reactant gas was flowed using the MFC at a flow rate of approximately 100 sccm (standard cubic centimeters per minute) to generate atmospheric plasma for etching the DLC thin film. Over the time, a depth of the DLC thin film etched away was measured for calculation of the etching speed. Here, with varying processing temperatures of 100, 150, 200, 250, and 300° C., five test samples were prepared.

As shown in FIG. 2A, as the processing temperature rises, the etching speed drastically increases. For example, when the DLC alignment film has a thickness of several micrometers, in order to attain a uniform profile for an area of a diameter of less than several millimeters, it is preferable to etch the DLC alignment film using atmospheric plasma at a temperature of approximately 300° C. or below. As shown in FIG. 2A, when the processing temperature is higher than 300° C., the etching speed is expected to drastically increase up to several micrometers per minute so that it is quite difficult to uniformly etch the alignment film. In addition, when the processing temperature is extremely low, substantially no etching is performed. Therefore, in order to get a constant etching speed in consideration of an operating efficiency, etching is preferably performed at a temperature of approximately of 100° C. or higher.

FIG. 2B illustrates an image of an alignment film locally etched by the alignment film etching apparatus shown in FIG. 1. As shown in FIG. 2B, the alignment film (B) was etched locally, for example, by a size of approximately 1 mm×2 mm, using the alignment film etching apparatus 100, thereby exposing an electrode pad (A) disposed under the alignment film (B). As described above, the alignment film etching apparatus 100 according to an embodiment of the present invention is capable of locally etching the alignment film (B) with an area of approximately 1 to 2 mm in diameter.

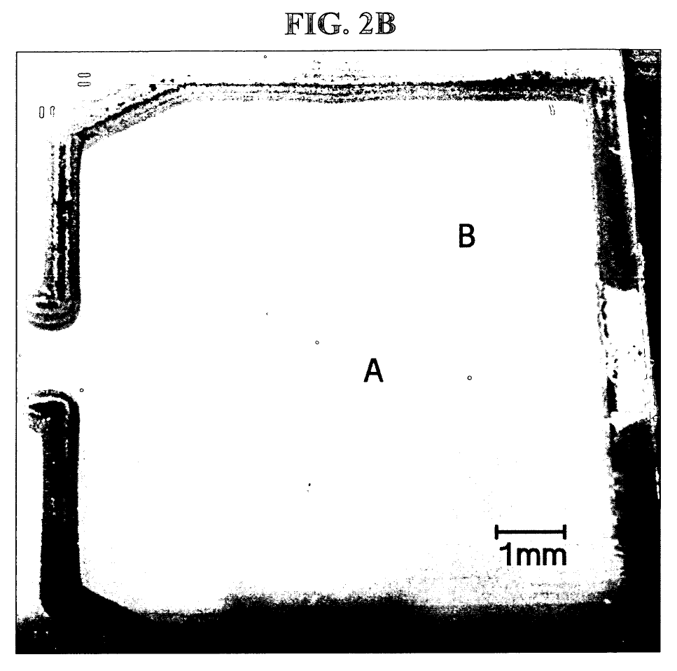

A method of fabricating a TFT substrate or a color filter substrate having the alignment film formed using the alignment film etching apparatus 100 with reference to FIGS. 3 through 5 will now be described.

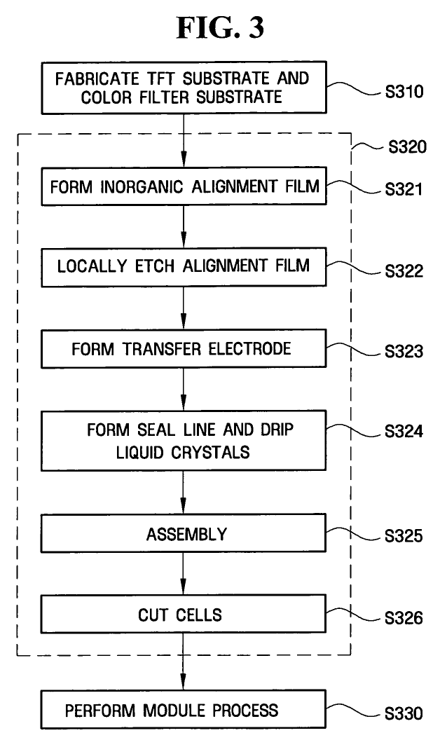

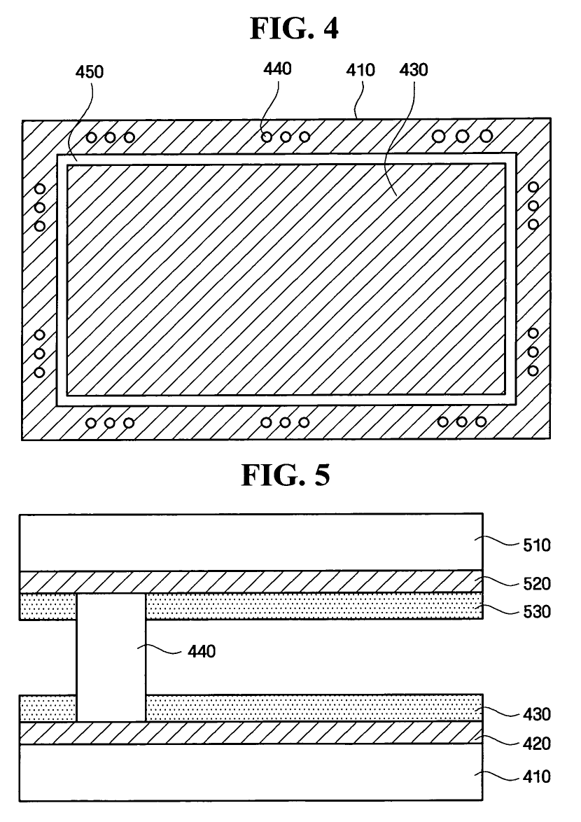

FIG. 3 is a flow diagram illustrating a method of fabricating a liquid crystal display device using an alignment film according to an embodiment of the present invention. FIG. 4 is a plan view of a TFT substrate having the alignment film fabricated by the method according to the embodiment of the present invention shown in FIG. 3. FIG. 5 is a cross-sectional view of a liquid crystal display device including the TFT substrate having the alignment film shown in FIG. 4 and a color filter substrate.

As shown in FIG. 3, a method of fabricating the liquid crystal display device includes forming a TFT substrate and a color filter substrate in operation S310, performing a liquid crystal cell process in operation S320, and performing a module process in operation S330.

Here, in operation S310, a thin film transistor array (TFT array) is formed on a large glass substrate (hereinafter to be referred to as a mother glass plate) to form a TFT substrate. A common electrode is formed on the color filter substrate.

After the TFT substrate and the color filter substrate are prepared in operation S310, the resultant structure is then subjected to the liquid crystal cell process in operation S320. In operation S320, the alignment film and the seal line are formed on the mother glass plate to define a plurality of liquid crystal cells, liquid crystals are dripped into the liquid crystal cells, the two mother glass plates are adhered to each other, and individual liquid crystal cells are cut using a variety of cutting tools, thereby producing a liquid crystal panel.

In operation S330, the module process for attaching driving circuits for supplying electrical signals to the liquid crystal cells is performed.

Now, the liquid crystal cell process (S320) will be described in greater detail.

First, as shown in FIG. 3, the liquid crystal cell process (S320) includes forming an inorganic alignment film in operation S321, locally etching the alignment film in operation S322, forming a transfer electrode in operation S323, forming a seal line and dripping liquid crystals in operation S324, assembling in operation S325, and cutting cell units in operation S326.

In operation S321, the inorganic alignment film is formed on the pixel electrode and common electrode formed over the TFT substrate and the color filter substrate, respectively. Here, the alignment film is formed to a uniform thickness throughout the substrate. During the process, liquid crystal molecules are uniformly arranged so as to impart a uniform display property over the entire screen.

The alignment film should be well adhered with a surface of an electrode made of ITO (Indium Tin Oxide) and capable of forming a uniformly thin film of approximately 1000 Å or less at a temperature of 200° C. or below. In addition, the alignment film should have high chemical stability so that it does not react with liquid crystals. Further, the alignment film should be electrically free from charge traps and have sufficiently high resistivity so that liquid crystal operation may not be affected. In addition, the alignment film should exhibit little change in physical property even at exposure to strong ultraviolet (UV) rays. In consideration of the foregoing, an inorganic alignment film may be used as the alignment film. Examples of the alignment film include a DLC thin film, hydrogenated amorphous silicon, silicon carbide (SiC), silicon dioxide (SIO₂), glass, silicon nitride (Si₃N₄), alumina (Al₂O₃), cerium IV oxide (CeO₂), tin oxide (SnO₂), zinc titanate (ZnTiO₂), and so on. The DLC thin film, which is transparent and hard, is used as the alignment film.

According to processing conditions, a process in which a surface of the alignment film is aligned in a predetermined orientation using an ion beam or atomic beam may be further performed.

After completing the alignment film forming process in operation S321, the alignment film disposed at a location corresponding to the transfer electrode on the TFT substrate or on the color filter substrate is locally etched in operation S322. The alignment film can be locally etched using atmospheric plasma with the alignment film etching apparatus 100 shown in FIG. 1. After locally etching the alignment films on the TFT substrate and the color filter substrate, the conductive film (e.g. wiring) and the common electrode disposed under the alignment films disposed on the TFT substrate and the color filter substrate, respectively, form the electrode pads for the respective transfer electrodes.

In another embodiment of the present invention, a YAG (Yttrium Aluminum Garnet) laser can be used to locally etch an inorganic alignment film. Since the YAG laser is capable of focusing on an object with an area of several millimeters in diameter, the alignment film can be easily locally etched. While etching an inorganic alignment film such as a DLC thin film, in order to prevent the transparent electrode or the common electrode disposed under the alignment film from being damaged during an etching process, a YAG laser having a wavelength of approximately 350 to 360 nm, for example, can be used. Such a YAG laser can be formed using a third harmonic.

In operation S323, the transfer electrode is formed on the electrode pad exposed by locally etching the alignment film on the TFT substrate or the color filter substrate. A common voltage is applied to the common electrode formed on the color filter substrate through the TFT substrate. To this end, a wiring is formed on the TFT substrate, and a conductive transfer electrode is formed on either the TFT substrate or the color filter substrate to connect the common electrode formed on the color filter substrate to the wiring formed on the TFT substrate.

In an embodiment of the present invention that follows, the transfer electrode formed on the TFT substrate will be explained by way of example.

The TFT substrate and the color filter substrate are securely combined to each other along the edge of the TFT substrate with the transfer electrode interposed therebetween and the seal line for receiving liquid crystals is formed in operation S324. As shown in FIG. 4, an alignment film 430 is formed on a TFT substrate 410, and a seal line 450 is arranged along the edge of a display region of the TFT substrate 410. The transfer electrode 440 is arranged on a peripheral area of the seal line 450.

Here, the seal line is formed by a sealant, which is an adhesive for adhering the TFT substrate and the color filter substrate with each other, and a spacer for maintaining a space for liquid crystals.

The spacer is mixed with the seal line disposed at a peripheral portion of a screen for the purpose of maintaining a uniform cell gap between the TFT substrate and the color filter substrate and is also formed in the active area of the liquid crystal panel.

In operation S324, liquid crystals to be interposed between the TFT substrate and the color filter substrate are dripped into the color filter substrate. While the liquid crystal dripping method is employed in this exemplary embodiment, it can be contemplated that a liquid crystal injection method using vacuum pressure may be used in alternative embodiments.

After aligning the TFT substrate having the seal line formed thereon with the color filter substrate having the liquid crystals dripped thereinto, the seal line is cured with ultraviolet rays or heat for assembling the TFT substrate and the color filter substrate with each other in operation S325. An alignment error allowed for attachment of two substrates is determined by a margin given when each substrate is designed. As shown in FIG. 5, a transparent electrode 420 disposed on the TFT substrate 410 having a predetermined exposed portion by locally etching the alignment film 430 is electrically connected by the transfer electrode 440 to a common electrode 520 disposed on the color filter substrate 510 having a predetermined exposed portion by locally etching the alignment film 530.

The assembled unit consisting of the TFT substrate and the color filter substrate is cut in units of cells to form a liquid crystal panel in operation S326. In the cell cutting process, a wheel made of diamond can be used.

Thereafter, an edge grinding process may be additionally performed. In the edge grinding process of the liquid crystal panel, lateral surfaces and edges of the TFT substrate and the color filter substrate are ground by rotating grinding stone made of diamond at a high speed.

Then, polarizing plates are attached to both surfaces of the liquid crystal panel, and then the resulting liquid crystal panel is subjected to a process of testing electrooptical properties and picture quality. The electrooptical properties of the liquid crystal panel are tested by applying a test signal to a shorting bar that is commonly connected to gate lines and data lines of the liquid crystal panel.

Thereafter, a module process is performed in operation S330. In operation S330, a driving IC is mounted on the liquid crystal panel and a printed circuit board (PCB) is attached thereto to then be assembled with a back light unit using a mold frame and a chassis.

Here, the driving IC is mounted on the liquid crystal panel by various mounting techniques, including a TAB (tape automated bonding), COB (chip on board), COG (chip on glass), and so on. The PCB includes various circuit elements having multiple layers and is electrically connected with the driving IC by a flexible printed circuit (FPC) to form a driving circuit unit of the liquid crystal display. Alternatively, the PCB may be separately formed by surface mount technology (SMT) to then be adhered to the liquid crystal panel. The liquid crystal panel having the driving IC and the PCB attached thereto is referred to as a liquid crystal display panel assembly.

Next, the back light unit that is separately prepared is assembled/combined to the mold frame and the chassis with the liquid crystal display panel assembly, thereby completing the liquid crystal display device.

As described above, according to the present invention, the alignment film etching apparatus 100 using atmospheric plasma is employed in patterning an inorganic alignment film, thereby optimizing a time required for fabricating the liquid crystal display and minimizing equipment necessary for fabricating the same. In performing a patterning process to attain a uniform profile by locally etching the alignment film 114, an etching speed using atmospheric plasma is an important factor. Thus, the power and frequency applied to the high voltage electrode 135 arranged around the nozzle 120, a supply amount of the reactant gas 160 induced from the MFC 140, a processing temperature for etching, and a shape of the nozzle 120 are appropriately adjusted, thereby etching the alignment film 114 with an area of less than several millimeters in diameter.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A method of fabricating an alignment film of a liquid crystal display device, comprising:
forming an alignment film on a substrate that has an electrode pad at a position corresponding to a transfer electrode for applying a voltage to a common electrode; and
etching the alignment film to expose the electrode pad without using a mask pattern.

2. The method of claim 1, wherein the etching includes locally etching a selected area of the alignment film.

3. The method of claim 1, wherein the etching of the alignment film is carried out using atmospheric plasma.

4. The method of claim 3, wherein the atmospheric plasma is formed of a reactant gas including air, He, O₂, F₂, or a combination thereof.

5. The method of claim 3, wherein the etching is carried out at a temperature of approximately 300° C. or below.

6. The method of claim 1, wherein the etching of the alignment film is carried out using a YAG laser.

7. The method of claim 6, wherein the YAG laser has a wavelength ranging from approximately 350 nm to approximately 360 nm.

8. The method of claim 7, wherein the YAG laser utilizes a third harmonic wave.

9. The method of claim 1, wherein the substrate is a color filter substrate and the electrode pad is connected to the common electrode.

10. The method of claim 1, wherein the substrate is a TFT substrate, and the etching of the alignment film is followed by forming the transfer electrode on the common electrode.

11. The method of claim 1, wherein the alignment film is made of material including diamond-like carbon (DLC).

12. The method of claim 1, wherein the etching of the alignment film includes locally etching the alignment film at an area having a diameter of several millimeters or less.

13. The method of claim 1, further comprising forming a seal line along an edge of a display region of the substrate.

14. The method of claim 13, wherein the transfer electrode is disposed on a peripheral area of the seal line.

15. An alignment film etching apparatus for manufacturing a liquid crystal display device, comprising:
a high voltage electrode to which a high frequency voltage power is supplied;
a ground electrode; and
a dielectric nozzle disposed between the high voltage electrode and the ground electrode, the dielectric nozzle generating atmospheric plasma for etching an alignment film to form an electrode pad at a portion corresponding to a transfer electrode for applying a common voltage supplied from a thin film transistor (TFT) substrate to a common electrode formed on a color filter substrate, wherein the alignment film is disposed on at least one of the TFT substrate and the color filter substrate.

16. The method of claim 15, wherein the dielectric nozzle has an inner diameter smaller than a diameter of the electrode pad.

17. The alignment film etching apparatus of claim 15, wherein an etched area of the alignment film has a diameter of several millimeters or less.

18. The alignment film etching apparatus of claim 15, wherein the atmospheric plasma is formed of a reactant gas including air, He, O₂, F₂, or a combination thereof.

19. The alignment film etching apparatus of claim 15, wherein the alignment film is made of material including diamond-like carbon (DLC).
